(19) United States
(12) Patent Application Publication
(10) Pub. No.: US 2004/0080421 A1
(43) Pub. Date: Apr. 29, 2004

(54) Monitoring and alert system

(76) Inventor: Neila Johnilynn Wunderlich, Loxahatchee, FL (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/676,683

(22) Filed: Sep. 30, 2003

Related U.S. Application Data
(60) Provisional application No. 60/418,560, filed on Oct. 16, 2002.

(51) Int. Cl. G08B 23/00

(52) U.S. Cl. 340/573.4; 340/539.13

(57) ABSTRACT

A monitoring and alert system including a remote central monitoring station which is typically located in the user's home, and a wrist device worn by the person to be monitored. The wrist device and the remote central monitoring system interface over a communication link. Upon the occurrence of predefined conditions namely, the person wearing the wrist device straying from pre-determined geographical boundaries, the remote central monitoring station is operative to transmit a signal in the home so that the concerned person in the home can take necessary action. The wrist device includes a distance display means, a direction locator means, a paging button means, a digital watch display means, an indicator means, and a signal means. The remote central monitoring station includes a distance display means, a set distance means, a paging button means, a digital watch display means, an indicator means, and a signal means.

### CROSS REFERENCES TO RELATED APPLICATIONS:

None.

Statement as to rights to inventions made under Federally sponsored research and development: U.S. Provisional Application for Patent 60/418,560, filed Oct. 16, 2002, with title, “Monitoring and Alert System” which is hereby incorporated by reference. Applicant claims priority pursuant to 35 U.S.C. Par. 119(e)(i).

### BACKGROUND OF THE INVENTION

1. Field of the Invention

The present invention relates generally to a monitoring and alert system and more particularly, to a system having a location determining device that monitors location with respect to pre-determined geographical boundaries, and to alert concerned individuals should the person being monitored stray outside those boundaries.

2. Brief Description of Prior Art

The present invention is intended for monitoring the whereabouts of certain individuals, such as the elderly or incapacitated living at home, as well as for generally monitoring the whereabouts of children while outside the home. The system will further alert concerned individuals should the person being monitored stray outside pre-determined geographical boundaries.

In recent years, the general population has become older and the number of elderly persons in the population have increased. Due to the high costs of nursing care and retirement centers as well as the psychological difficulty of placing a family member into an institution, alternatives are desired for those individuals who do not require constant attention or observation, and wish to continue to live in their own home. To assist in this regard, it is often necessary to keep track of or monitor the whereabouts of the person while the person is immediately outside the home. Likewise, with regard to young children playing outside the home, for safety and other obvious reasons, it is important to monitor their whereabouts when outside.

A variety of apparatus and systems have been proposed heretofore directed to solutions to the problems as discussed hereinbelow. U.S. Pat. No. 3,885,235 is adapted to monitor passively normal, routine activities of an individual in his or her own residence and to produce alarm conditions in the event these routine activities are not performed during some specified period of time, for example, a period of up to twenty-four hours.

U.S. Pat. No. 3,885,235 discloses a direction sensitive photo cell optics arrangement, and an electronic timer having two time periods, specifically, a short time period and a long time period, a pre-alarm cycle effective prior to an actual alarm cycle and during which an alarm condition can be canceled or aborted, and remote alarm transmission. The direction sensitive photo cell arrangement detects entry into the bathroom for example, and causes the timing cycle of the electronic timer to be reduced to its short time period. If the individual does not exit within the pre-set short time period, a pre-alarm cycle will be initiated and, if the pre-alarm cycle is not terminated or aborted by the individual, an actual alarm cycle will be initiated after passage of a short period of time.

There are further systems in which the monitor person wears a radio frequency (RF) transmitter that communicates with a monitoring unit connected to the monitored person's home telephone and is arranged to call in status reports without intervention. In theory, such monitoring systems provide for continuous monitoring of a monitored person during periods when the monitored person is required to be at home. However, such systems have proven unreliable in practice, tending to generate false alarms, and further installation of the hardware required to implement an RF transmitter based monitoring system is relatively difficult.

Another patented alarm system is disclosed in U.S. Pat. No. 3,662,111, which is activated by a default of the owner. The system generates a local alarm at predetermined time intervals which, if not reacted to by the owner, results in automatic dialing and transmission of a prerecorded message.

Still another emergency alarm response system is disclosed in U.S. Pat. No. 4,064,368, in which a digital transceiver is connected to a patient's telephone line. The system may be triggered by an emergency button or when a timer achieves a predetermined value. The system transmits identification and alarm codes to a compatible digital transceiver at a remote monitoring station and simultaneously activates an enunciation at the patient's residence. An operator at the monitoring station thereupon dispatches an individual to the patient's residence to further investigate the incident.

As will be seen from the subsequent description, the preferred embodiments of the present invention overcome shortcomings of the prior art.

### SUMMARY OF THE INVENTION

The present invention relates to a monitoring and alert system having a location determining device that monitors location with respect to pre-determined geographical boundaries, and alerts concerned individuals should the subject stray outside those boundaries. The monitoring and alert system generally includes a remote central monitoring station which can be located in the user's home, and a wrist device worn by the person to be monitored. The wrist device and the remote central monitoring system interface over a communication link. The wrist device includes a distance display means, a direction locator means, a paging button means, a digital watch display means, and an indicator means. The remote central monitoring station includes a distance display means, a set distance means, a direction locator means, a paging button means, a digital watch display means, an indicator means, and a signal means that either visually flashes or audibly signals indicating that the monitored person is outside the pre-determined geographical boundaries.

### BRIEF DESCRIPTION OF THE DRAWINGS

FIG. 1 illustrates a wrist device of the preferred embodiment of the present invention, a monitoring and alert system.

FIG. 2 illustrates a remote central monitoring station of the monitoring and alert system of FIG. 1.

FIG. 3 illustrates a schematic diagram of the monitoring station and the wrist device.

FIG. 4 illustrates a portion of the operating program of the monitoring station.

### DESCRIPTION OF THE PREFERRED EMBODIMENT

In accordance with the present invention, a monitoring and alert system is disclosed. The system provides an alert to concerned individuals should the monitored person stray from pre-determined geographical boundaries, and further provides an indication at a remote central monitoring station and wrist device of the approximate location of the monitored person. The remote central monitoring station and wrist device interface over a communication link, and signal means are provided to the remote central monitoring station when the wearer of the wrist device strays beyond the predetermined geographical boundaries.

Specifically, it will be noted in the drawings that the apparatus relates to a monitoring and alert signaling system used primarily for monitoring the elderly or incapacitated living at home, as well as for generally monitoring the whereabouts of children while outside the home. In the broadest context, the apparatus consists of components configured and correlated with respect to each other so as to attain the desired objective.

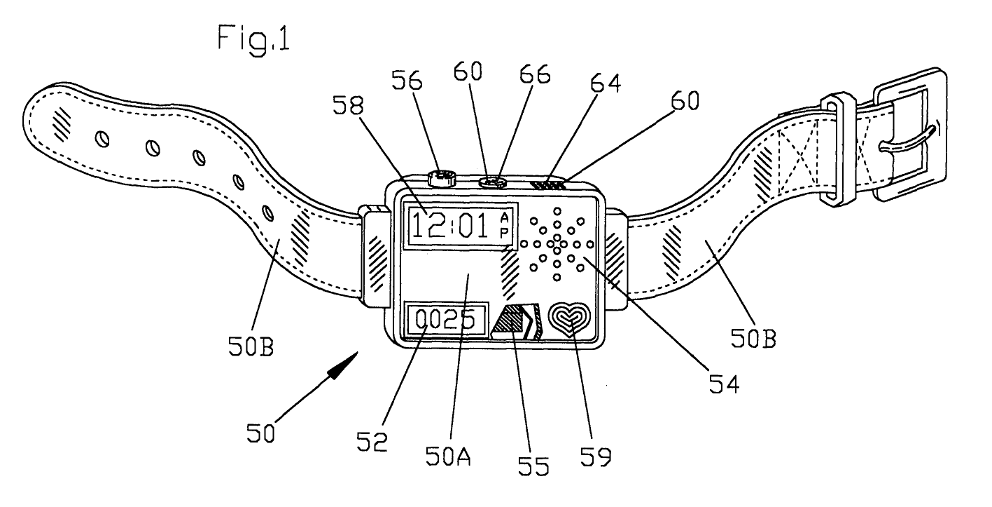

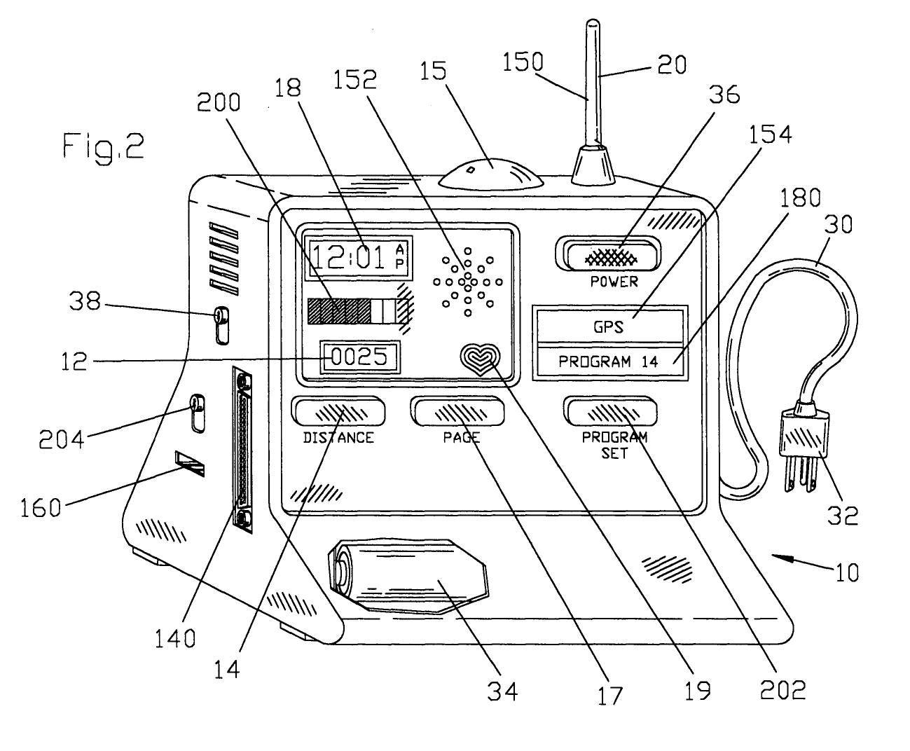

Referring to FIGS. 1-2, the system generally includes a remote central monitoring station 10 which can be located in the user's home, and a wrist device 50 having a watch face 50A and watch band 50B worn by the person to be monitored. In the preferred embodiment, the watch band 50B including locking means 204 that the wrist device 50 is only removed by authorized persons.

The wrist device 50 and the remote central monitoring station 10 interface over a communication link (not shown) and specifically, the wrist device 50 transmits signals to the remote central monitoring station 10 as to the location of the wrist device 50. Upon the occurrence of predefined conditions namely, the person wearing the wrist device 50 straying from pre-determined geographical boundaries, the remote central monitoring station 10 is operative to transmit a signal in the home so that the concerned person in the home may take necessary action.

The communication link may comprise of a radio frequency communications link or any other suitable means for transmission of signals from the wrist device 50 to the remote central monitoring station 10. When a radio frequency communications link is employed, the wrist device 50 includes a radio frequency transmitter 55 and the remote central monitoring station 10 includes a radio frequency receiver 15 for wireless transmission of signals from the wrist device 50 to the remote central monitoring station 10. The radio frequency transmitter 55 and receiver 15 may be any type well known in the art.

The wrist device 50 provides continuous signaling, and further includes a distance display means 52 which is operative to continuously display the distance the wrist device 50 is from the remote central monitoring station 10, a direction locator means 54 indicating the direction the remote central monitoring station 10 is situate in relationship to the wrist device 50, a paging button means 56, a digital watch display means 58, an indicator means 59 that displays an indicator light when the wrist device 50 and the remote central monitoring station 10 are linked, and a signal means 60 that vibrates, visually flashes 66 or audibly signals 64 indicating that the monitored person is beyond the pre-determined geographical boundaries selected.

The corresponding remote central monitoring station 10 further includes a distance display means 12 which is operative to continuously display the distance the wrist device 50 is from the remote central monitoring station 10, a set distance means 14 for selecting said pre-determined geographical boundaries, a paging button means 17, a digital time display means 18, an indicator means 19 that displays an indicator light when the wrist display 50 and the remote central monitoring station 10 are linked, and a signal means 20 that visually flashes or audibly signals indicating that the monitored person is beyond the pre-determined geographical boundaries selected in the set distance means 14.

In application, the remote central monitoring station 10 continuously monitors the distance between the remote central monitoring station 10 and the wrist device 50. In the event the person wearing the wrist device 50 strays beyond the pre-determined geographical boundaries of the set distance means 14, the signal means 20 visually flashes or audibly signals indicating that the monitored person is beyond the predetermined geographical boundaries set in the set distance means 14.

In the preferred embodiment, the remote central monitoring station 10 is appropriately connected to the electrical lighting system of the home where the monitoring station 10 is situate. When the signal means 20 of the monitoring station 10 is activated as described above, the lighting system of the home can likewise provide a detectable output signal.

The signal means 200 may be a visual signal, an audible signal, or any other signal to provide an output signal detectable by concerned individuals monitoring the remote central monitoring station 10.

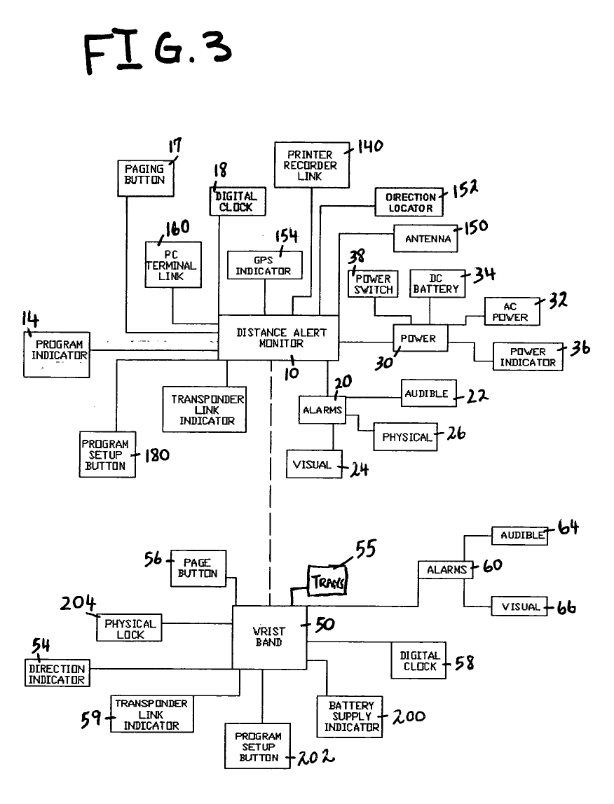

Referring to FIG. 3 provides a schematic view detailing the portable wrist device 50 and the monitoring station 10. The monitoring station 10 includes a source of power 30 which can include a source of AC power 32, backup DC power 34, a power indicator light 36 and a power switch 38 to select power to the monitoring station 10.

The monitoring station 10 can include an antenna 150, direction locator 152 and GPS indicator 154. The GPS indicator 154 detects distance and direction to the wrist device 50 using global positioning systems technology. The monitoring station 10 can include a digital clock 18 and a print recorder link 140 that can be used to record events. A PC computer terminal link 160 can provide the ability to program the monitoring station 10 and can download data from the monitoring station to a PC computer (not shown).

Alarms 20 can include an audible 22, a visual 24 or physical 26 signaling devices used individually or in combination depending upon the requirements. The visual 24 might be a flashing light and the physical 26 a vibration for example.

The paging button 17 allows an operator at the monitoring station 10 to set off an alarm 60 in the wrist device 50 to aid in the location of the wrist device 50 when required. A program setup button 180 allows the user to select alarm parameters such as the distance and direction at which a particular wrist device 50 can get prior to setting off an alarm. The program can also select a time delay given an alarm condition prior to sounding an alarm. The program indicator 14 may display the parameters chosen.

The wrist device 50 can include battery backup power 200. It can also include a program setup button 202 allowing the user to select alarm parameters such as a flashing light or vibration when the wrist device 50 is out of communication range with the monitoring station 10. The transponder link indicator 59 indicates a link exists to the monitoring station 10 from the wrist device 50 from transmitter 55 to antenna 150. A direction indicator 54 sends a radio signal through transmitter 55 and can be picked up by the antenna 150 of the monitoring station 10 indicating position and distance based on strength of signal for example. A physical lock 204 prevents a patient or individual who may suffer from dementia for example, from removing the wrist device 50. The pager button 56 can send a signal to the monitoring station 10 and, the wrist device 50 can further include a digital clock 58.

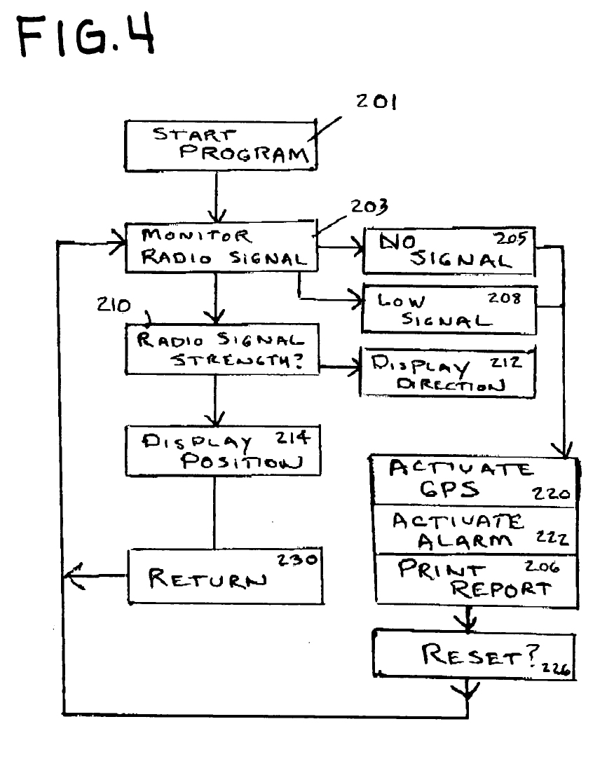

FIG. 4 shows a schematic view of the operation of the monitoring station 10. A program 201 is initially set by the user. Parameters such as distance, direction, radio signal strength, and alarm delay can be set. For example, the program 201 can monitor the strength of radio signal 203, if the radio signal 203 is not present 205 an alarm 20 will sound and a print report signal 206 will be sent to the printer link 140, the PC terminal link 160, or both. If the radio signal is present but below a set parameter, a below parameter signal 208 can be sent that might sound an alarm signal different from that sent with no signal. The signal strength parameter can define an area around the monitoring station 10 where a person being monitored can travel. A delay might be built in so that a below parameter signal 208 would need to be present for a period of time prior to the alarm 20 being setoff in order to help prevent some false alarms.

Normally, the below parameter signal indicates that the wrist unit 50 and person wearing it have wondered beyond an acceptable range as indicated by a weak radio signal. During an alarm sequence reports 206 can be printed and distance and direction can still be displayed at the monitor 10. If the wrist unit 50 is outside radio range and there is no signal or a weak signal, the last known location of the individual wearing the wrist unit 50 can still be displayed and/or the GPS positioning device 154 can be activated and the location of the now missing wearer can be tracked and reported at the monitoring station 10. Time referenced locations can be stored through said PC terminal link and printed out. The GPS indicator from the wrist unit 50 might pulse on and off to conserve battery 200 power if the wrist unit 50 is out of range for too long.

If the radio signal is within parameter 210 a position 214 and direction can still be displayed 212 at the monitoring station 10. If there is no signal 205 or a low signal 208 the program can activate the global positioning system 220, activate an alarm 222 and print a report 206. If an alarm condition is triggered then a user must reset 226 the program at the monitoring station 10 before the program will continue. If no alarm condition is sensed, the program will return 230 and repeat.

Though shown as a portable wrist worn device 50, it will be understood that the portable device could be carried with a monitored person in many ways including but not limited to an ankle bracelet, in a pocket or even as an implant. Further, while the central monitoring station 10 may be shown and described as a stationary device that can be located in the user's home, it should be understood that the station 10 can be carried by a monitoring person in many ways including but not limited to a portable wrist worn device.

Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents, rather than by the examples given.

I claim:

1. A monitoring and alert system that monitors location with respect to predetermined geographical boundaries, and to alert should the person being monitored stray beyond those selected boundaries, said monitoring and alert system comprising:
a remote central monitoring station,
a wrist device having a watch face and watch band,
communication link means for interfacing the remote central monitoring station with the wrist device,
wherein the remote central monitoring system further comprising a distance display means, a set distance means, a paging button means, a digital watch display means, an indicator means, and a signal means,
wherein the wrist device further comprising a distance display means, a direction locator means, a paging button means, a digital watch display means, an indicator means, and a signal means,
wherein the remote central monitoring station including means to continuously monitor distance between the remote central monitoring station and the wrist device.

2. The monitoring and alert system as recited in claim 1, wherein the remote central monitoring station is typically located in the user's home, and the wrist device is worn by the person to be monitored.

3. A monitoring and alert system that monitors location and alerts based on signals outside parameters comprising:
a programable monitoring station including an antenna receiving a signal indicating a distance to a portable device,
a communication link interfacing the programable monitoring station with the portable device,
wherein the programable monitoring station includes a distance display, a direction display and a monitor alarm, wherein said monitoring station monitors the distance from said monitoring station to said portable device and generates an alarm signal upon said distance exceeding a set parameter indicating distance.

4. The monitoring and alert system as recited in claim 3, wherein said portable device is worn on a wrist of a person whose location is to be monitored.

5. The monitoring and alert system as recited in claim 3, wherein a GPS device in said portable device transmits a signal indicating said distance and a direction from said monitoring station to said portable device.

6. The monitoring and alert system as recited in claim 3, wherein said portable device includes a link indicator that senses a radio link exists between said monitoring station and said portable device and said link indicator will send an alarm signal to an alarm in said portable device if said radio link is broken.

7. The monitoring and alert system as recited in claim 6, wherein the GPS device sends a signal indicating a position of said portable device if said radio link is broken.

8. The monitoring and alert system as recited in claim 7, wherein said alarm in said portable device includes at least one alarm from set including a visual, physical and sound alarm.

9. A monitoring and alert system that monitors location and alerts based on signals outside parameters comprising:
a monitoring station including an antenna receiving a radio signal indicating a distance to a portable device,
a radio communication link interfacing the monitoring system with the portable device,
wherein the monitoring station includes a distance display, a direction display and a monitor alarm,
wherein said monitoring station monitors the distance from said monitoring station to said portable device and generates a monitoring station alarm signal upon said distance and direction being outside a set parameter.

10. The monitoring and alert system as recited in claim 9, wherein a GPS device in said portable device transmits a signal indicating said distance and a direction from said monitoring station when said communication link is broken.

11. The monitoring and alert system as recited in claim 9, wherein said portable device includes a link indicator that senses a radio link exists between said monitoring station and said portable device and said link indicator will send a portable device alarm signal to an alarm in said portable device if said radio link is broken and wherein said alarm signal will trigger a GPS device in said portable device.

12. The monitoring and alert system as recited in claim 11, wherein said portable device is positioned on a person to be monitored and includes a lock to prevent the portable device from being removed from said person.

13. The monitoring and alert system as recited in claim 12, wherein said monitoring station includes a clock and wherein said monitoring station prints time referenced locations of said GPS device once said alarm signal is sent.
